(19) United States
(12) Patent Application Publication
(10) Pub. No.: US 2026/0104023 A1
(43) Pub. Date: Apr. 16, 2026

(54) INTAKE APPARATUS FOR INTERNAL COMBUSTION ENGINE

(71) Applicant: TOYOTA JIDOSHA KABUSHIKI KAISHA, Toyota-shi (JP)

(72) Inventor: Seiji OKAMURA, Toyota-shi (JP)

(73) Assignee: TOYOTA JIDOSHA KABUSHIKI KAISHA, Toyota-shi (JP)

(21) Appl. No.: 19/354,151

(22) Filed: Oct. 9, 2025

(30) Foreign Application Priority Data
Oct. 15, 2024 (JP) 2024-179827

(51) Int. Cl. F02M 35/10

(52) U.S. Cl. CPC F02M 35/10157; F02M 35/10209; F02M 35/1038

(57) ABSTRACT

An intake apparatus, for an internal combustion engine, includes a first intake passage connected to a first bank of the internal combustion engine, a second intake passage connected to a second bank of the internal combustion engine, a first turbocharger provided in the first intake passage, a second turbocharger provided in the second intake passage, a first throttle valve provided in the first intake passage at a position downstream of the first turbocharger, a second throttle valve provided in the second intake passage at a position downstream of the second turbocharger, and a communication pipe connected to a position downstream of the first throttle valve in the first intake passage and a position downstream of the second throttle valve in the second intake passage.

### CROSS-REFERENCE TO RELATED APPLICATION

This application is based upon and claims the benefit of priority of the prior Japanese Patent Application No. 2024-179827, filed on Oct. 15, 2024, the entire contents of which are incorporated herein by reference.

### TECHNICAL FIELD

The present disclosure relates to an intake apparatus for an internal combustion engine.

### BACKGROUND

In some cases, a plurality of intake passages are provided corresponding to banks of a V-type engine, and a turbocharger is provided for each intake passage (for example, see Japanese Unexamined Patent Application Publication No. 2020-020323).

However, a difference in intake pressure might occur between the left and right banks due to a variation in performance of the turbocharger or the like.

### SUMMARY

It is therefore an object of the present disclosure to provide an intake apparatus, for an internal combustion engine, capable of reducing a difference in intake pressure.

The above object is achieved by an intake apparatus, for an internal combustion engine, includes: a first intake passage connected to a first bank of the internal combustion engine; a second intake passage connected to a second bank of the internal combustion engine; a first turbocharger provided in the first intake passage; a second turbocharger provided in the second intake passage; a first throttle valve provided in the first intake passage at a position downstream of the first turbocharger; a second throttle valve provided in the second intake passage at a position downstream of the second turbocharger; and a communication pipe connected to a position downstream of the first throttle valve in the first intake passage and a position downstream of the second throttle valve in the second intake passage.

The intake apparatus, for the internal combustion engine, may further include: a first supercharging pressure sensor provided in the first intake passage at a position downstream of the first turbocharger and upstream of the first throttle valve; and a second supercharging pressure sensor provided in the second intake passage downstream of the second turbocharger and upstream of the second throttle valve.

The first intake passage may include a first intake manifold, the first intake manifold may be connected to the first bank, the second intake passage may include a second intake manifold, the second intake manifold may be connected to the second bank, a first pressure sensor may be provided in the first intake manifold, and a second pressure sensor may be provided in the second intake manifold.

### BRIEF DESCRIPTION OF THE DRAWINGS

FIG. 1 is a schematic view illustrating an intake apparatus according to an embodiment;

FIG. 2 is a view illustrating a pressure difference; and

FIGS. 3A and 3B are views illustrating exhaust pressure.

### DETAILED DESCRIPTION

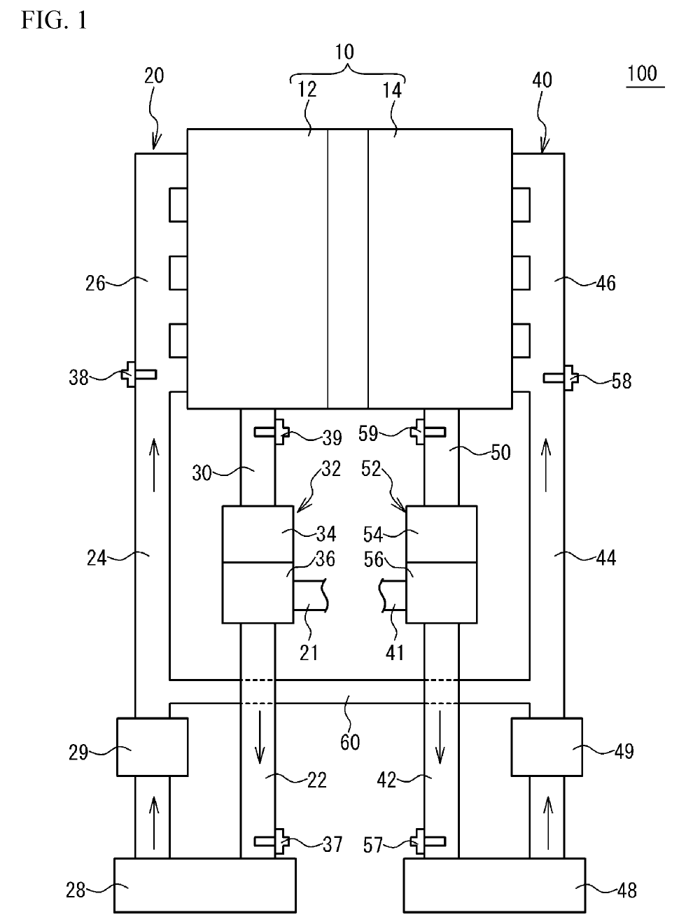

An intake apparatus for an internal combustion engine according to the present embodiment will be described below with reference to the drawings. FIG. 1 is a schematic view illustrating an intake apparatus 100 according to the embodiment. The air sucked from the intake apparatus 100 is supplied to an internal combustion engine 10. The internal combustion engine 10 is, for example, a V-type engine, and includes a bank 12 (first bank, right bank) and a bank 14 (second bank, left bank). A plurality of cylinders are arranged in each of the banks 12 and 14.

The intake apparatus 100 includes an intake passage 20, an intake passage 40, and a communication pipe 60. The intake passage 20 (first intake passage) is connected to the bank 12 of the internal combustion engine 10 and introduces air into the cylinders of the bank 12. The intake passage 40 (second intake passage) is connected to the bank 14 of the internal combustion engine 10, and introduces air into the cylinders of the bank 14.

The intake passage 20 includes an intake passage 21, an intake passage 22, an intake passage 24, and an intake manifold 26 (first intake manifold). The intake passage 20 is provided with a turbocharger 32 (first turbocharger), an intercooler 28, a throttle valve 29 (first throttle valve), a supercharging pressure sensor 37 (first supercharging pressure sensor), and a pressure sensor 38 (first pressure sensor).

The turbocharger 32 includes a turbine housing 34 and a compressor housing 36. The turbine housing 34 houses a turbine. The compressor housing 36 houses a compressor. An exhaust passage 30 is connected to the bank 12 of the internal combustion engine 10 and the turbine housing 34. An exhaust pressure sensor 39 is provided in the exhaust passage 30.

The intake passage 21 is located at the most upstream side of the intake passage 20 and is connected to the compressor housing 36. The intake passage 22 is connected to the compressor housing 36 and the intercooler 28. The intake passage 24 is provided downstream of the intercooler 28. The intake manifold 26 is located on the most downstream side of the intake passage 20 and is connected to the intake passage 24.

The throttle valve 29 is provided in the intake passage 24. The supercharging pressure sensor 37 is provided in the intake passage 22 and is located upstream of the throttle valve 29 and the intercooler 28 and downstream of the turbocharger 32. The pressure sensor 38 is provided in the intake manifold 26.

The intake passage 40 includes an intake passage 41, an intake passage 42, an intake passage 44, and an intake manifold 46 (second intake manifold). The intake passage 40 is provided with a turbocharger 52 (second turbocharger), an intercooler 48, a throttle valve 49 (second throttle valve), a supercharging pressure sensor 57 (second supercharging pressure sensor), and a pressure sensor 58 (second pressure sensor).

The turbocharger 52 includes a turbine housing 54 and a compressor housing 56. An exhaust passage 50 is connected to the bank 14 of the internal combustion engine 10 and the turbine housing 54. An exhaust pressure sensor 59 is provided in the exhaust passage 50.

The intake passage 41 is located at the most upstream side of the intake passage 40 and is connected to the compressor housing 56. The intake passage 42 is connected to the compressor housing 56 and the intercooler 48. The intake passage 44 is provided downstream of the intercooler 48. The intake manifold 46 is located on the most downstream side of the intake passage 40 and is connected to the intake passage 44.

The throttle valve 49 is provided in the intake passage 44. The supercharging pressure sensor 57 is provided in the intake passage 42 and is located upstream of the throttle valve 49 and the intercooler 48 and downstream of the turbocharger 52. The pressure sensor 58 is provided in the intake manifold 46.

The communication pipe 60 is connected to a position downstream of the throttle valve 29 in the intake passage 24 and a position downstream of the throttle valve 49 in the intake passage 44. In other words, the communication pipe 60 is connected to a position downstream of the throttle valve 29 and upstream of the intake manifold 26 in the intake passage 20, and is connected to a position downstream of the throttle valve 49 and upstream of the intake manifold 46 in the intake passage 40. Air flows between the intake passage 20 and the intake passage 40 through the communication pipe 60. For example, the inner diameter of the communication pipe 60 may be equal to the inner diameter of the intake passage or is smaller than the inner diameter of the intake passage.

Air is introduced into the intake passage 20 through the intake passage 21, flows through the intake passage 21, the intake passage 22, the intercooler 28, the intake passage 24, and the intake manifold 26, and is introduced into the bank 12 of the internal combustion engine 10. The intercooler 28 cools the air. The flow rate of the air changes in accordance with the opening degree of the throttle valve 29. The larger the opening degree, the higher the flow rate. The smaller the opening degree, the smaller the flow rate.

A mixture of air and fuel is generated in the cylinders of the bank 12, and the mixture is combusted. Exhaust gas generated by the combustion is discharged through the exhaust passage 30. The exhaust gas is introduced into the turbine housing 34 of the turbocharger 32, and the turbine rotates. The compressor is coupled to the turbine and rotates synchronously with the turbine. Air is supercharged by the compressor.

Air is introduced into the bank 14 through the intake passage 40. The flow rate of the air changes in accordance with the opening degree of the throttle valve 49. The exhaust gas generated in the bank 14 is introduced into the turbine housing 54 of the turbocharger 52, and air is supercharged.

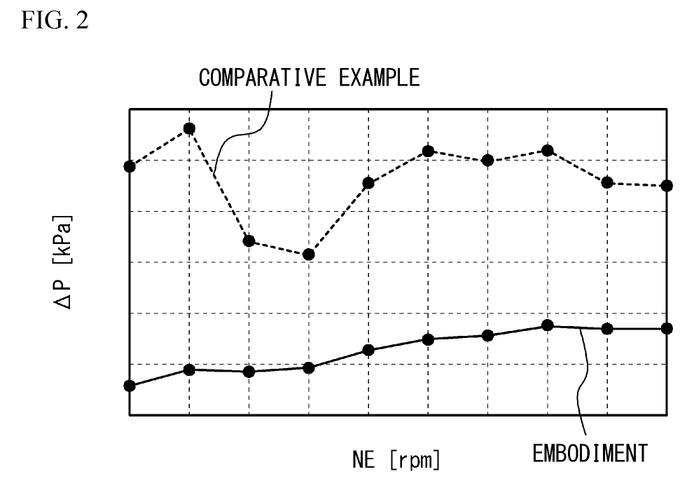

FIG. 2 is a view illustrating a pressure difference. The horizontal axis represents the rotational speed NE of the internal combustion engine 10. The vertical axis represents a pressure difference (intake pressure difference) ΔP between the intake manifold 26 and the intake manifold 46. ΔP is the difference between the pressure detected by the pressure sensor 38 and the pressure detected by the pressure sensor 58. It is assumed that the opening degree of the throttle valve 29 and the opening degree of the throttle valve 49 are equal to each other. The dotted line represents a comparative example. The comparative example is an example in which the communication pipe 60 is not provided. The solid line represents the embodiment.

As illustrated in FIG. 2, the pressure difference ΔP is large in the comparative example. The pressure difference ΔP in the embodiment is smaller than that in the comparative example. In the embodiment, the pressure difference ΔP decreases as the rotational speed NE decreases. The pressure difference ΔP increases as the rotational speed NE increases. The pressure in the intake manifold 26 and the pressure in the intake manifold 46 change in the same manner in accordance with the rotational speed NE.

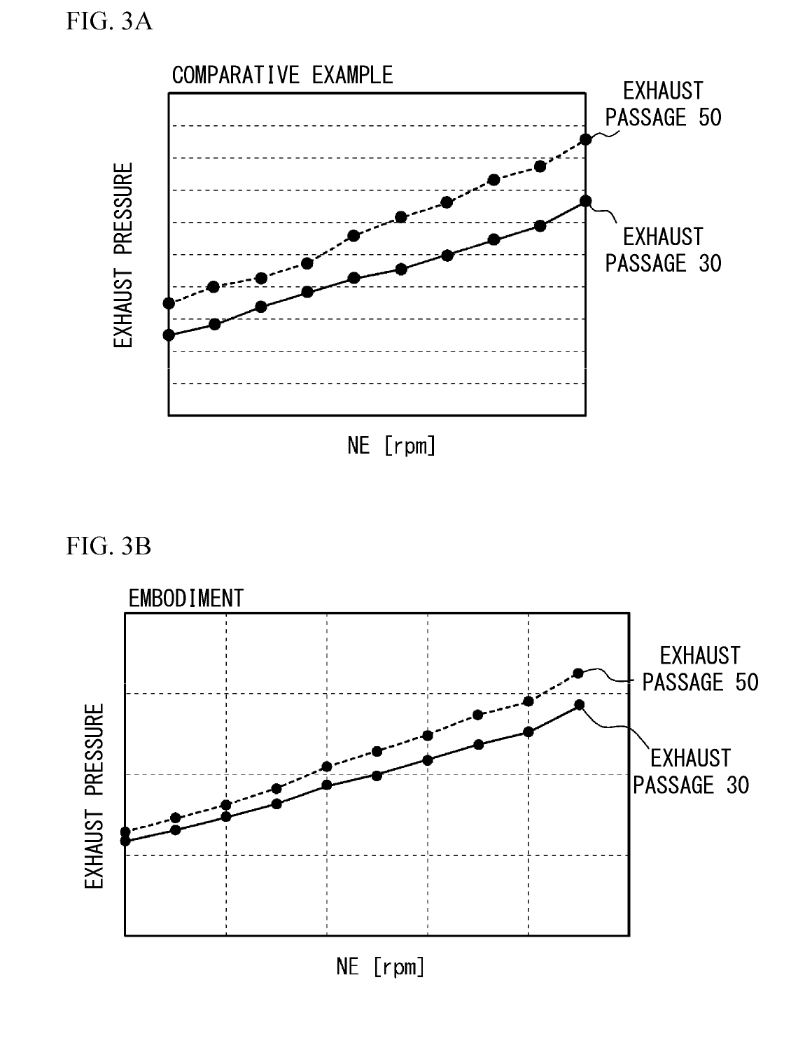

FIGS. 3A and 3B are views illustrating the exhaust pressure. FIG. 3A illustrates the exhaust pressure in the comparative example. FIG. 3B illustrates the exhaust pressure in the embodiment. The horizontal axis represents the rotational speed NE. The vertical axis represents exhaust pressure. A solid line represents the pressure in the exhaust passage 30 detected by the exhaust pressure sensor 39. The dotted line represents the pressure in the exhaust passage 50 detected by the exhaust pressure sensor 59.

In both of FIGS. 3A and 3B, the lower the rotational speed, the lower the exhaust pressure. The higher the rotational speed, the higher the exhaust pressure. The difference between the exhaust pressure in the exhaust passage 30 and the exhaust pressure in the exhaust passage 50 is large in the example of FIG. 3A, and is small in the example of FIG. 3B. That is, according to the embodiment, the difference in exhaust pressure is reduced.

According to the embodiment, the communication pipe 60 is connected to the intake passage 20 at a position downstream of the throttle valve 29 and to the intake passage 40 at a position downstream of the throttle valve 49. Air flows between the intake passage 24 and the intake passage 44 through the communication pipe 60. The intake pressure becomes nearly equal between the intake passage 20 and the intake passage 40. That is, as illustrated in FIG. 2, the pressure difference ΔP becomes small. The variation in torque between the bank 12 and the bank 14 is suppressed.

As illustrated in FIG. 3B, the difference in the exhaust pressure is also reduced by providing the communication pipe 60. The pressure of the exhaust gas introduced into the turbocharger 32 and the pressure of the exhaust gas introduced into the turbocharger 52 become close to uniform. Therefore, the turbocharger 32 and the turbocharger 52 have substantially the same rotational speed. The supercharging pressure of the intake passage 20 and the supercharging pressure of the intake passage 40 are also about the same. The variation in torque between the bank 12 and the bank 14 is suppressed.

The supercharging pressure sensor 37 is provided in the intake passage 20 at a position downstream of the turbocharger 32 and upstream of the throttle valve 29. The supercharging pressure sensor 57 is provided in the intake passage 40 at a position downstream of the turbocharger 52 and upstream of the throttle valve 49. A failure can be detected by comparing the pressure detected by the supercharging pressure sensor 37 with the pressure detected by the supercharging pressure sensor 57. In a normal state, the pressure detected by the supercharging pressure sensor 37 and the pressure detected by the supercharging pressure sensor 57 are substantially the same. If these pressures are significantly different, it is estimated that a failure such as a failure of the supercharging pressure sensor, blockage of the passage, or a malfunction of the turbocharger has occurred.

The pressure sensor 38 is provided in the intake manifold 26. The pressure sensor 58 is provided in the intake manifold 46. A failure can be detected by comparing the pressure detected by the pressure sensor 38 with the pressure detected by the pressure sensor 58. In a normal state, the pressure detected by the pressure sensor 38 and the pressure detected by the pressure sensor 58 are approximately the same. If these pressures differ significantly, it is assumed that a fault has occurred.

One supercharging pressure sensor and one pressure sensor are provided in each of the two intake passages 20 and 40, and the pressures are compared, whereby a failure can be detected. No additional sensor for fault detection is required.

The cost is reduced.

Although some embodiments of the present disclosure have been described in detail, the present disclosure is not limited to the specific embodiments but may be varied or changed within the scope of the present disclosure as claimed.

What is claimed is:

1. An intake apparatus, for an internal combustion engine, comprising:
a first intake passage connected to a first bank of the internal combustion engine;
a second intake passage connected to a second bank of the internal combustion engine;
a first turbocharger provided in the first intake passage;
a second turbocharger provided in the second intake passage;
a first throttle valve provided in the first intake passage at a position downstream of the first turbocharger;
a second throttle valve provided in the second intake passage at a position downstream of the second turbocharger; and
a communication pipe connected to a position downstream of the first throttle valve in the first intake passage and a position downstream of the second throttle valve in the second intake passage.

2. The intake apparatus, for the internal combustion engine, according to claim 1, further comprising:
a first supercharging pressure sensor provided in the first intake passage at a position downstream of the first turbocharger and upstream of the first throttle valve; and
a second supercharging pressure sensor provided in the second intake passage downstream of the second turbocharger and upstream of the second throttle valve.

3. The intake apparatus, for the internal combustion engine, according to claim 1, wherein
the first intake passage includes a first intake manifold,
the first intake manifold is connected to the first bank,
the second intake passage includes a second intake manifold,
the second intake manifold is connected to the second bank,
a first pressure sensor is provided in the first intake manifold, and
a second pressure sensor is provided in the second intake manifold.
